(19) United States
(12) Patent Application Publication
(10) Pub. No.: US 2012/0278024 A1
(43) Pub. Date: Nov. 1, 2012

(54) POSITION ESTIMATION APPARATUS AND METHOD USING ACCELERATION SENSOR

(75) Inventors: Hyong Euk Lee, Gyeonggi-do (KR); Bho Ram Lee, Seongnam-si (KR); Sang Hyun Kim, Hwaseong-si (KR); Won Chul Bang, Seongnam-si (KR); Chan Gook Park, Seoul (KR); Chul Woo Kang, Seoul (KR); Chang Ho Kang, Seoul (KR)

(73) Assignee: SAMSUNG ELECTRONICS CO., LTD., Suwon-si (KR)

(21) Appl. No.: 13/368,819

(22) Filed: Feb. 8, 2012

(30) Foreign Application Priority Data
Apr. 27, 2011 (KR) 10-2011-0039478

(51) Int. Cl. G06F 19/00; G01P 21/00

(52) U.S. Cl. 702/87

(57) ABSTRACT

A position estimation apparatus may measure 3-axis accelerations by at least two acceleration sensors disposed at different distances from a center of rotation of the position estimation apparatus, measure 3-axis angular velocity by a gyro sensor, and detect an azimuth angle using a geomagnetic sensor. Using the 3-axis accelerations measured by the acceleration sensors and the 3-axis angular velocity measured by the gyro sensor, the position estimation apparatus calculates gravity acceleration from which a rotational motion component is extracted.

### CROSS-REFERENCE TO RELATED APPLICATIONS

This application claims the priority benefit of Korean Patent Application No. 10-2011-0039478, filed on Apr. 27, 2011, in the Korean Intellectual Property Office, the disclosure of which is incorporated herein by reference.

### BACKGROUND

1. Field

Example embodiments of the following description relate to a position estimation apparatus, and more particularly, to a position estimation apparatus used in a handheld-type terminal.

2. Description of the Related Art

Recently, use of portable terminals such as mobile communication terminals and personal digital assistants (PDAs) is rapidly expanding due to ease of portability. Due to such expansion, service providers and terminal manufacturers are competitively developing more convenient portable terminals to secure more users.

For example, the portable terminals provide various functions such as a phone book, a game console, a scheduler, a short message service (SMS), a multimedia message service (MMS), a cell broadcasting service, an Internet service, an e-mail service, a wakeup call, an mp3 player, and a digital camera, for example. Furthermore, an operational method of the portable terminals is not limited to a keypad or a touch screen employing buttons, but is also developed to respond to motions such as moving and tilting of the portable terminal.

In general, an algorithm for calculating a position includes a process of integrating angular velocities of a moving body, measured by a gyro sensor. The position calculation algorithm is useful only with a precision gyro sensor. Using a low-cost micro-electromechanical system (MEMS) gyro sensor, errors generated by bias and noise of the sensor are accumulated due to the integrating process, accordingly causing a positional error in a short time. To minimize this error, an additional sensor is used in conjunction with the gyro sensor for the position calculation using the MEMS gyro sensor. For example, an attitude reference system (ARS) method that calculates only a tilt angle using an acceleration sensor and a gyro sensor, and an attitude and heading reference system (AHRS) method that calculates a tilt angle and an azimuth angle may be used.

The conventional AHRS method calculates a position using an inertial measurement unit (IMU) constituted by a 3-axis accelerometer, a gyro sensor, and a geomagnetic sensor. However, in general, the AHRS method for calculating a position using gravity acceleration is susceptible to a dynamic motion. Since the acceleration measured by the acceleration sensor in the AHRS method is a sum of the gravity acceleration and motion acceleration, acceleration of an actual motion cannot be differentiated, which is why the AHRS method is susceptible to the dynamic motion.

### SUMMARY

The foregoing and/or other aspects are achieved by providing a position estimation apparatus including at least two acceleration sensors to measure 3-axis accelerations; a gyro sensor to measure 3-axis angular velocity; and a gravity acceleration compensation unit to calculate gravity acceleration from which a motion component is extracted, using the 3-axis accelerations measured by each of the acceleration sensors and the 3-axis angular velocity measured by the gyro sensor.

The motion component may be a rotational motion component based on a center of rotation.

The position estimation apparatus may further include a geomagnetic sensor to detect an azimuth angle; and a position estimation unit to estimate a position of the position estimation apparatus using the gravity acceleration, the 3-axis angular velocity, and the azimuth angle.

The position estimation apparatus may further include a gyration radius calculation unit to calculate a radius of gyration of the position estimation apparatus, using the 3-axis acceleration, measured by one of the at least two acceleration sensors, and the gravity acceleration.

The gyration radius calculation unit may estimate a motion trajectory of the position estimation apparatus using the radius of gyration and the 3-axis angular velocity.

At least two of the acceleration sensors may be disposed at different distances from a center of rotation of the position estimation apparatus.

At least two of the acceleration sensors may be disposed collinearly and at different distances corresponding to a center of rotation of the position estimation apparatus.

The gravity acceleration compensation unit may calculate the gravity acceleration from which the motion component is extracted from the 3-axis accelerations, using the 3-axis accelerations and the distances from the acceleration sensors to the center of rotation of the position estimation apparatus.

The foregoing and/or other aspects are achieved by providing a position estimation method including sensing motion by measuring 3-axis accelerations by at least two acceleration sensors and measuring 3-axis angular velocity by a gyro sensor; and calculating gravity acceleration from which a motion component is extracted, using the 3-axis accelerations measured by each of the acceleration sensors and the 3-axis angular velocity measured by the gyro sensor.

The motion component may be a rotational motion component based on a center of rotation.

The sensing may further include detecting an azimuth angle using a geomagnetic sensor; and estimating a position of the position estimation apparatus using the gravity acceleration, the 3-axis angular velocity, and the azimuth angle.

The position estimation method may further include calculating a radius of gyration of the position estimation apparatus, using the 3-axis acceleration measured by one of the acceleration sensors and the gravity acceleration.

The position estimation method may further include estimating a motion trajectory of the position estimation apparatus, using the radius of gyration and the 3-axis angular velocity.

At least two of the acceleration sensors may be disposed at different distances from a center of rotation of the position estimation apparatus.

At least two of the acceleration sensors may be disposed collinearly and at different distances corresponding to a center of rotation of the position estimation apparatus.

The calculating may calculate the gravity acceleration from which the motion component is extracted from the 3-axis accelerations, using the 3-axis accelerations and the distances from the acceleration sensors to the center of rotation of the position estimation apparatus.

Additional aspects, features, and/or advantages of example embodiments will be set forth in part in the description which follows and, in part, will be apparent from the description, or may be learned by practice of the disclosure.

When an acceleration sensor is used in measuring a tilt corresponding to gravity acceleration, an error may be generated by motion acceleration. When a position of an object in a rotational motion is estimated, the embodiments may increase accuracy of measuring a tilt corresponding to a gravity direction, by removing a rotational motion component from acceleration measured by at least two acceleration sensors, arranged at different distances from a center of rotation of a position estimation apparatus, and a gyro sensor.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a structure of a position estimation apparatus estimating a position using acceleration of gravity from which a rotational motion component is extracted, according to example embodiments;

FIG. 2 illustrates a structure of a sensor signal processing unit of the position estimation apparatus of FIG. 1;

FIG. 3 illustrates a position estimation unit of the position estimation apparatus of FIG. 1;

FIG. 4 illustrates a motion of moving with a position estimation apparatus in hand, the position estimation apparatus being equipped with two acceleration sensors; and

FIG. 5 illustrates a process of estimating a position using a plurality of acceleration sensors.

### DETAILED DESCRIPTION

Reference will now be made in detail to example embodiments, examples of which are illustrated in the accompanying drawings, wherein like reference numerals refer to like elements throughout. Example embodiments are described below to explain the present disclosure by referring to the figures.

When a position estimation apparatus according to example embodiments is used in a handheld manner, a user generally performs a rotational motion made about a joint such as an elbow and a shoulder of the user. Therefore, acceleration measured by an acceleration sensor would include motion acceleration of a rotational motion component, in addition to gravity acceleration.

Example embodiments suggested hereinafter adopt at least two acceleration sensors to calculate gravity acceleration more accurately, by removing a rotational motion component from acceleration measured by the acceleration sensors, so that accurate position estimation is achieved.

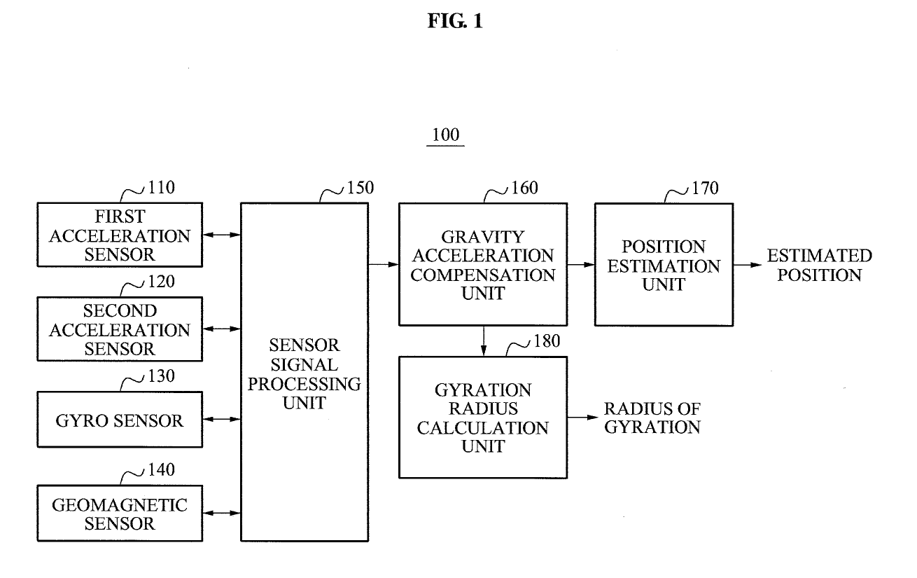

FIG. 1 illustrates a position estimation apparatus 100 estimating a position using gravity acceleration, from which a rotational motion component is extracted, according to example embodiments.

Referring to FIG. 1, the position estimation apparatus 100 includes a first acceleration sensor 110, a second acceleration sensor 120, a gyro sensor 130, a geomagnetic sensor 140, a sensor signal processing unit 150, a gravity acceleration compensation unit 160, a position estimation unit 170, and a gyration radius calculation unit 180.

The first acceleration sensor 110 and the second acceleration sensor 120, being disposed at different distances from a center of rotation of the position estimation apparatus 100, each measure 3-axis acceleration.

According to a representative example of the arrangement of acceleration sensors, the first acceleration sensor 110 and the second acceleration sensor 120 may be disposed at different positions to be directed to the center of rotation of the position estimation apparatus 100. Here, the center of rotation may be an elbow or shoulder of the user because, when the user uses the position estimation apparatus 100 in a handheld manner, a motion of the user becomes a rotational motion made about a joint such as the elbow or shoulder.

Although FIG. 1 shows an example embodiment adopting two acceleration sensors, it should be understood that more acceleration sensors may be adopted. Here, at least two of the acceleration sensors are disposed at different distances from the center of rotation of the position estimation apparatus 100.

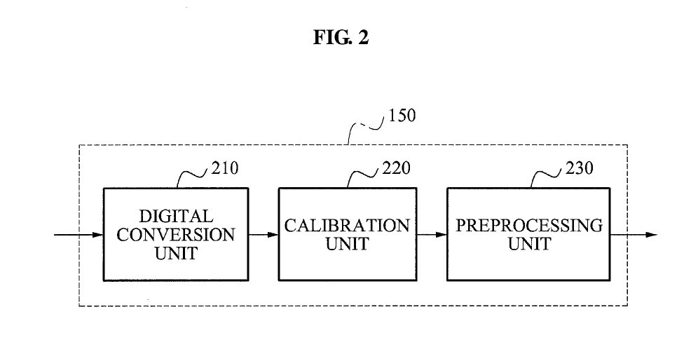

The gyro sensor 130 may measure 3-axis angular velocity indicating rotation about three axes of the position estimation apparatus 100. The geomagnetic sensor 140 may detect an azimuth angle of the position estimation apparatus 100 in consideration of a geomagnetic field. The sensor signal processing unit 150 may convert analog sensor signals obtained through the first acceleration sensor 110, the second acceleration sensor 120, the gyro sensor 130, and the geomagnetic sensor 140, into digital sensor signals for digital calculation. The sensor signal processing unit 150 may be configured as shown in FIG. 2.

FIG. 2 illustrates a structure of the sensor signal processing unit 150 of FIG. 1.

Referring to FIG. 2, the sensor signal processing unit 150 includes a digital conversion unit 210, a calibration unit 220, and a preprocessing unit 230.

The digital conversion unit 210 may convert analog sensor signals obtained in the form of voltage through the first acceleration sensor 110, the second acceleration sensor 120, the gyro sensor 130, and the geomagnetic sensor 140, into digital signals.

The calibration unit 220 calibrates the digital signals converted by the digital conversion unit 210 to reflect preset properties of the first acceleration sensor 110, the second acceleration sensor 120, the gyro sensor 130, and the geomagnetic sensor 140.

The preprocessing unit 230 may perform preprocessing related to the digital signals calibrated by the calibration unit 220, so that the calibrated digital signals may be read by the gravity acceleration compensation unit 160, the position estimation unit 170, and the gyration radius calculation unit 180.

The gravity acceleration compensation unit 160 calculates the gravity acceleration from which the motion component is extracted, using the 3-axis accelerations measured by the first acceleration sensor 110 and the second acceleration sensor 120, and the 3-axis angular velocity measured by the gyro sensor 130. Here, the motion component to be extracted may be a rotational motion component based on the center of rotation.

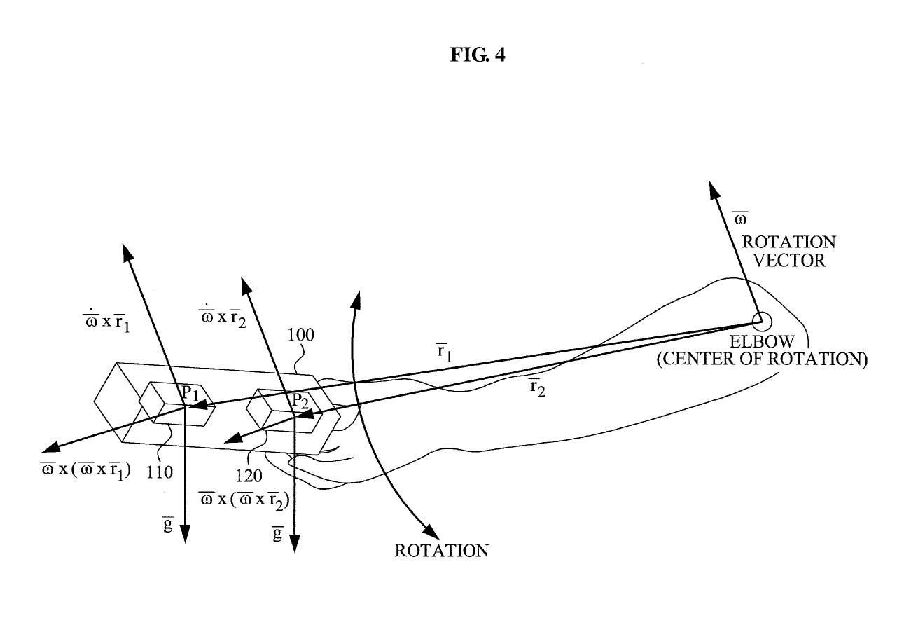

Calculation of the gravity acceleration by the gravity acceleration compensation unit 160 will be described in further detail with reference to FIG. 4.

FIG. 4 illustrates a motion of moving with a position estimation apparatus in hand, the position estimation apparatus being equipped with two acceleration sensors.

Referring to FIG. 4, two different positions are denoted by P₁ and P₂, respectively indicating the first acceleration sensor 110 and the second acceleration sensor 120. The first acceleration sensor 110 and the second acceleration sensor 120 are disposed at a distance r̅₁ and r̅₂, respectively, from a center of rotation axis. Here, ω̅ denotes a rotational angular-velocity vector corresponding to a specific position of an elbow, by way of example. The rotational angular-velocity vector ω̅ may be indirectly measured by an angular velocity sensor mounted in the position estimation apparatus. g̅ denotes a gravity acceleration vector, r̅₁ denotes a position vector of the first acceleration sensor 110, r̅₂ denotes a position vector of the second acceleration sensor 120, and \overline{\dot{ω}} denotes angular acceleration.

The acceleration measured between the positions p1 and p2 is calculated by Equation 1 below.

ā₁= g̅+ \overline{\dot{ω}}× r̅₁+ ω̅×( ω̅× r̅₁) ā₂= g̅+ \overline{\dot{ω}}× r̅₂+ ω̅×( ω̅× r̅₂) [Equation 1]

First, the angular acceleration \overline{\dot{ω}}, which is an unknown variable, may be obtained by Equation 5 and as shown in Equation 2 below.

ā₁−ā₁= \overline{\dot{ω}}×( r̅₁− r̅₂)+ ω̅×( ω̅×( r̅₁− r̅₂)) [Equation 2]

Presuming that b̅= r̅₁− r̅₂, the angular acceleration \overline{\dot{ω}} may be rearranged as Equation 3 as follows.

[ b̅×]· \overline{\dot{ω}}=(ā₁−ā₂)− ω̅×( ω̅× b̅) [Equation 3]

A matrix [ b̅×] in Equation 3 may be expressed as in Equation 4 below.

$$[ \overline{b} \times ] = [ \begin{matrix}0 & - {b}_{z} & {b}_{y} \\ {b}_{z} & 0 & - {b}_{x} \\ - {b}_{y} & {b}_{x} & 0\end{matrix} ] \qquad [ Equation 4 ]$$

Here, since the matrix [ b̅×] is singular, an inverse matrix of the matrix [ b̅×] is unobtainable.

Therefore, the angular acceleration \overline{\dot{ω}} is also unobtainable from Equation 3. However, ratio of respective components of \overline{\dot{ω}}, that is, \dot{ω}ₓ:\dot{ω}_{y}:\dot{ω}_{z}, may be obtained from Equation 3. In addition, an approximate value of \overline{\dot{ω}} may be obtained by taking a derivative of the measured angular velocity, as shown in Equation 5 below. Also, both the aforementioned methods may be used to calculate \overline{\dot{ω}}.

$${ω}^{\dot{\_}} ≅ \frac{Δ \overline{ω}}{Δ t} \qquad [ Equation 5 ]$$

Next, the gravity acceleration may be calculated using Equations 7 to 16.

First, for convenience, terms related to the calculated angular acceleration and the measured angular velocity will be defined as shown in Equation 7 below.

D=([ \overline{\dot{ω}}×]+[ ω̅×][ ω̅×]) [Equation 7]

Here, [ \overline{\dot{ω}}×] and [ ω̅×] may be defined as shown in Equation 8 below.

$$[ \overline{ω} \times ] = [ \begin{matrix}0 & - {ω}_{z} & {ω}_{x} \\ {ω}_{z} & 0 & - {ω}_{y} \\ - {ω}_{x} & {ω}_{y} & 0\end{matrix} ] [ {ω}^{\dot{\_}} \times ] = [ \begin{matrix}0 & - {\dot{ω}}_{z} & {\dot{ω}}_{x} \\ {\dot{ω}}_{z} & 0 & - {\dot{ω}}_{y} \\ - {\dot{ω}}_{x} & {\dot{ω}}_{y} & 0\end{matrix} ] \qquad [ Equation 8 ]$$

Application of Equation 7 to Equation 1 may result in Equation 9 below.

ā₁= g̅+D r̅₁ā₂= g̅+D r̅₂ [Equation 9]

When calculating the position by the position estimation apparatus 100, the gravity acceleration g̅ is necessary, which may be calculated through Equations 10 to 16.

First, a vector product of measurements of the first acceleration sensor 110 and the second acceleration sensor 120 may be expressed by Equation 10 as follows.

$$\begin{matrix}{\overline{a}}_{1} \times {\overline{a}}_{2} = ( \overline{g} + D {\overline{r}}_{1} ) \times ( \overline{g} + D {\overline{r}}_{2} ) \\ = [ \overline{g} \times ] D {\overline{r}}_{2} + [ D {\overline{r}}_{1} \times ] \overline{g} + [ D {\overline{r}}_{1} \times ] D {\overline{r}}_{2}\end{matrix} \qquad [ Equation 10 ]$$

Here, [ g̅×]D r̅₂+[D r̅₁×] g̅ in Equation 10 may be rearranged as shown in Equation 11 below.

$$\begin{matrix}[ \overline{g} \times ] D {\overline{r}}_{2} + [ D {\overline{r}}_{1} \times ] \overline{g} = [ \overline{g} \times ] D {\overline{r}}_{2} - [ \overline{g} \times ] D {\overline{r}}_{1} \\ = [ \overline{g} \times ] D {\overline{r}}_{2} - [ \overline{g} \times ] D ( {\overline{r}}_{2} + \overline{b} ) \\ = - [ \overline{g} \times ] D \overline{b}\end{matrix} \qquad [ Equation 11 ]$$

In addition, using D b̅=ā₁−ā₂ of Equation 9, Equation 12 may be derived as follows.

[ g̅×]D b̅=[ g̅×](ā₁−ā₂) [Equation 12]

Also, [D r̅₁×]D r̅₂ of Equation 10 may be rearranged as in Equation 13 below.

$$\begin{matrix}[ D {\overline{r}}_{1} \times ] D {\overline{r}}_{2} = ( det D ) {D}^{- T} ( {\overline{r}}_{1} \times {\overline{r}}_{2} ) \\ = ( det D ) {D}^{- T} ( {\overline{r}}_{1} \times ( {\overline{r}}_{1} - \overline{b} ) ) \\ = ( det D ) {D}^{- T} ( \overline{b} \times {\overline{r}}_{1} ) \\ = ( det D ) {D}^{- T} [ \overline{b} \times ] {\overline{r}}_{1}\end{matrix} \qquad [ Equation 13 ]$$

Here, det D denotes a determinant calculation result of D and D^{-T} denotes a transpose matrix of an inverse matrix of D.

Equation 10 may be rearranged using Equation 11 and Equation 13, as shown in Equation 14 below.

ā₁×ā₂=[ g̅×](ā₁−ā₂)+(det D)D^{-T}[b×] r̅₁ [Equation 14]

Here, when r̅₁ and b are vectors of the same direction, it may be expressed as Equation 15 below. When r̅₁ and b are vectors of the same direction, this means the first acceleration sensor 110 and the second acceleration sensor 120 are disposed at different positions, being directed to the center of rotation of the position estimation apparatus 100.

[b×] r̅₁=0 [Equation 15]

Accordingly, application of Equation 15 to Equation 14 may result in Equation 16 as follows.

−[(ā₁−ā₂)×] g̅=ā₁×ā₂ [Equation 16]

In Equation 16, although [(ā₁−ā₂)×] is singular and therefore does not have an inverse matrix, ratio of magnitudes of the components of g̅ may be obtained. Here, g̅ may be calculated using | g̅|≅9.81(m/s²).

The position estimation unit 170 may estimate the position of the position estimation apparatus 100, using the gravity acceleration calculated by the gravity acceleration compensation unit 160, the 3-axis angular velocity measured by the gyro sensor 130, and the azimuth angle measured by the geomagnetic sensor 140.

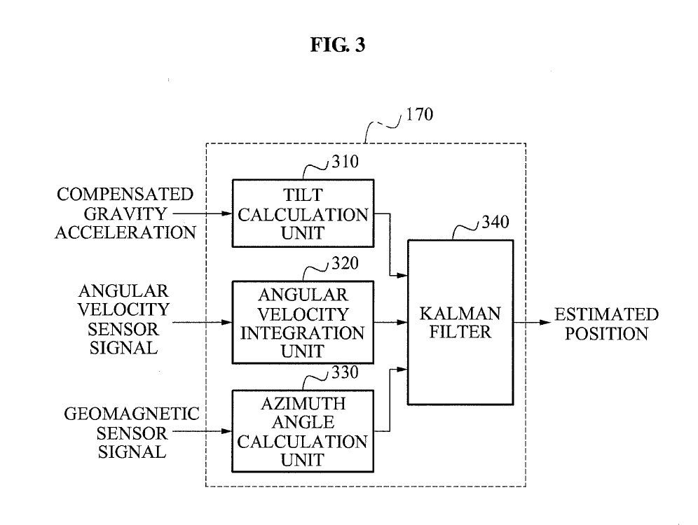

The position estimation using the compensated gravity acceleration and the measured angular velocity by the position estimation unit 170 may be performed in various methods. According to example embodiments as shown in FIG. 3, the position may be calculated through a combination of a tilt corresponding to the gravity acceleration, obtained using the gravity acceleration, a position obtained by integrating angular velocities, and an azimuth angle obtained using the geomagnetic sensor. Although this method combines the calculated position information, a method of combining measured information may also be used. In this case, an estimation algorithm such as a Kalman filter may be used.

FIG. 3 illustrates the position estimation unit 170 of FIG. 1.

Referring to FIG. 3, the position estimation unit 170 includes a tilt calculation unit 310, an angular velocity integration unit 320, an azimuth angle calculation unit 330, and a Kalman filter 340.

The tilt calculation unit 310 may calculate a tilt of the position estimation apparatus 100 using the gravity acceleration calculated by the gravity acceleration compensation unit 160. The angular velocity integration unit 320 may integrate the 3-axis angular velocity received through the gyro sensor 130. The azimuth angle calculation unit 330 may check the azimuth angle received through the geomagnetic sensor 140. The Kalman filter 340 may output the estimated position by combining the tilt corresponding to the gravity acceleration, the position obtained through integration of the angular velocity, and the azimuth angle obtained by the geomagnetic sensor, through the Kalman filter algorithm.

The gyration radius calculation unit 180 may calculate a radius of gyration of the position estimation apparatus 100, using the 3-axis acceleration measured by one of the first acceleration sensor 110 and the second acceleration sensor 120, and the gravity acceleration calculated by the gravity acceleration compensation unit 160.

After the gyration radius calculation unit 180 calculates the angular acceleration and the gravity acceleration through the gravity acceleration compensation unit 160, unknown variables in Equation 9 are the radiuses of gyration r̅₁ and r̅₂. The radiuses of gyration may be led by rearranging Equation 9 to Equation 17 in relation to r̅₁ or r̅₂ as follows.

r̅₁=D⁻¹(ā₁− g̅) [Equation 17]

The gyration radius calculation unit 180 may estimate a motion trajectory indicating a position to which the position estimation apparatus 100 is moved, using the calculated radius of gyration and the 3-axis angular velocity measured by the gyro sensor 130.

Hereinafter, a position estimation method using the acceleration sensors in the position estimation apparatus 100 will be described with reference to the accompanying drawings.

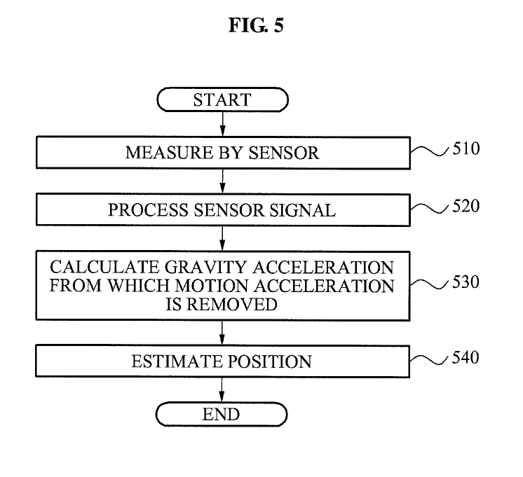

FIG. 5 illustrates a process of estimating a position using a plurality of acceleration sensors.

Referring to FIG. 5, in operation 510, the position estimation apparatus 100 may measure 3-axis accelerations using at least two acceleration sensors, measure 3-axis angular velocity using a gyro sensor, and detect an azimuth angle using a geomagnetic sensor. Here, at least two of the at least two acceleration sensors may be disposed at different distances from a center of rotation of the position estimation apparatus 100.

In operation 520, the position estimation apparatus 100 may convert analog sensor signals obtained through the acceleration sensors, the gyro sensor, and the geomagnetic sensor, into digital sensor signals for digital calculation.

In addition, in operation 530, the position estimation apparatus 100 may calculate gravity acceleration from which a rotational motion component is extracted, using the 3-axis accelerations measured by the acceleration sensors and the 3-axis angular velocity measured by the gyro sensor.

Additionally, the position estimation apparatus 100 may estimate a position of the position estimation apparatus 100 using the gravity acceleration, the 3-axis angular velocity, and the azimuth angle, in operation 540.

The position estimation apparatus 100 may calculate the radius of gyration of the position estimation apparatus 100, using the 3-axis acceleration measured by at least one of the acceleration sensors, and the gravity acceleration calculated in operation 530.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A position estimation apparatus comprising:
at least two acceleration sensors to measure 3-axis accelerations;
a gyro sensor to measure 3-axis angular velocity; and
a gravity acceleration compensation unit to calculate gravity acceleration, from which a motion component is extracted, using the 3-axis accelerations measured by each of the acceleration sensors and the 3-axis angular velocity measured by the gyro sensor.

2. The position estimation apparatus of claim 1, wherein the motion component is a rotational motion component based on a center of rotation.

3. The position estimation apparatus of claim 1, further comprising:
a geomagnetic sensor to detect an azimuth angle; and
a position estimation unit to estimate a position of the position estimation apparatus using the gravity acceleration, the 3-axis angular velocity, and the azimuth angle.

4. The position estimation apparatus of claim 1, further comprising a gyration radius calculation unit to calculate a radius of gyration of the position estimation apparatus, using the 3-axis acceleration measured by at least one of the acceleration sensors and the gravity acceleration.

5. The position estimation apparatus of claim 4, wherein the gyration radius calculation unit estimates a motion trajectory of the position estimation apparatus using the radius of gyration and the 3-axis angular velocity.

6. The position estimation apparatus of claim 1, wherein at least two of the acceleration sensors are disposed at different distances from a center of rotation of the position estimation apparatus.

7. The position estimation apparatus of claim 1, wherein at least two of the acceleration sensors are disposed collinearly and at different distances corresponding to a center of rotation of the position estimation apparatus.

8. The position estimation apparatus of claim 7, wherein the gravity acceleration compensation unit calculates gravity acceleration from which the motion component is extracted, using the 3-axis accelerations and the distances from the acceleration sensors to the center of rotation of the position estimation apparatus.

9. A position estimation method comprising:
measuring 3-axis accelerations by at least two acceleration sensors;
measuring 3-axis angular velocity by a gyro sensor; and
calculating gravity acceleration from which a motion component is extracted, using the 3-axis accelerations measured by each of the acceleration sensors and the 3-axis angular velocity measured by the gyro sensor.

10. The position estimation method of claim 9, wherein the motion component is a rotational motion component based on a center of rotation.

11. The position estimation method of claim 9, further comprising:
detecting an azimuth angle using a geomagnetic sensor; and
estimating a position of the position estimation apparatus using the gravity acceleration, the 3-axis angular velocity, and the azimuth angle.

12. The position estimation method of claim 9, further comprising:
calculating a radius of gyration of the position estimation apparatus, using the 3-axis acceleration measured by at least one of the acceleration sensors and the gravity acceleration.

13. The position estimation method of claim 12, further comprising:
estimating a motion trajectory of the position estimation apparatus, using the radius of gyration and the 3-axis angular velocity.

14. The position estimation method of claim 9, wherein at least two of the acceleration sensors are disposed at different distances from a center of rotation of the position estimation apparatus.

15. The position estimation method of claim 9, wherein at least two of the acceleration sensors are disposed collinearly and at different distances corresponding to a center of rotation of the position estimation apparatus.

16. The position estimation method of claim 15, wherein calculating gravity acceleration from which the motion component is extracted uses the 3-axis accelerations and the distances from the acceleration sensors to the center of rotation of the position estimation apparatus.

17. The position estimation apparatus of claim 1, further comprising:
a sensor signal processing unit comprising:
a digital conversion unit to convert analog signals from the sensors into digital signals,
a calibration unit to calibrate the digital signals to reflect preset properties of the sensors, and
a preprocessing unit to perform preprocessing related to the digital signals so that the calibrated digital signals may be read by the gravity acceleration compensation unit.

18. The position estimation method of claim 9, further comprising:
converting the analog signals from the sensors into digital signals,
calibrating the digital signals to reflect preset properties of the sensors, and
performing preprocessing related to the digital signals so that the calibrated digital signals may be read by the gravity acceleration compensation unit.

19. A position estimation apparatus comprising:
at least two acceleration sensors to measure multiple axis accelerations;
a gyro sensor to measure multiple axis angular velocity; and
a gravity acceleration compensation unit to calculate a motion component based on the multiple axis accelerations and angular velocity, while compensating for gravitational effects.
